(19) United States
(12) Patent Application Publication
(10) Pub. No.: US 2012/0260572 A1
(43) Pub. Date: Oct. 18, 2012

(54) Construction Element Covered With Vegetation For Horizontal Pitched And/Or Vertical Surfaces Of Structures

(75) Inventor: Wolfgang Behrens, Gross Ippener (DE)

(73) Assignee: XF TECHNOLOGIES B.V., Arnheim (NL)

(21) Appl. No.: 13/504,417

(22) PCT Filed: Oct. 21, 2010
(86) PCT No.: PCT/DE2010/001240

§ 371 Date: Jun. 5, 2012

(30) Foreign Application Priority Data
Oct. 26, 2009 (DE) 10 2009 050 715.9

(51) Int. Cl. A01G 9/02

(52) U.S. Cl. 47/65.9

(57) ABSTRACT

A construction element covered with vegetation for horizontal, pitched and/or vertical surfaces of structures. The construction element has a lower base plate, which is embodied as an insulating board, and an upper vegetation layer with shorter and/or taller plants. A plant adhesive layer is arranged between the insulating board and the vegetation layer. A layer of a material that renders possible plant growth for shorter and/or taller plants is adhered on the adhesive layer. The adhesive layer is embodied in a non-vapor retardant manner so that it is permeable for water vapor.

The invention relates to a construction element covered with vegetation for horizontal, pitched and/or vertical surfaces of structures, with a lower base plate, which is embodied as an insulating board, and with an upper vegetation layer with shorter and/or taller plants.

It has long been known to cover roofs or façades or other surfaces of structures with vegetation. In addition to the important ecological significance, covering with vegetation also has an important function from an optical point of view and overall represents an optical benefit for cityscapes and landscapes. Further advantages are the long life of the surfaces covered with vegetation due to the protection against UV radiation, the low maintenance, the improvement in air quality and retention of rainwater.

The covering with vegetation of roofs with horizontal or pitched surfaces as well as façades with vertical surfaces can be planned and provided from the start in the case of the new construction of a building. In addition, covering with vegetation also lends itself when, for example, an existing flat roof of a building has to be repaired and replaced due to a damaged seal or other damage.

In the case of first-time coverage with vegetation as well as with a retroactive coverage with vegetation of areas of building—for example of roofs—as is known certain values for thermal insulation must be maintained for the roof which are established in building regulations in order to maintain specified thermal resistance values.

From document EP 0 202 346 A1 a prefabricated construction element with vegetation is already known for this purpose, in which a lower base plate is embodied as an insulating board. On the surface of this insulating board a structural layer is arranged, which contains a substrate and which is covered with vegetation. The known construction element can thus be used to cover surfaces with vegetation, and due to the insulating board the construction element thereby has a defined thermal resistance value.

Even for a non-expert, it is not difficult to produce a large-area vegetation coverage on a roof area by simply placing several construction elements next to one another, whereby overall a roof area completely covered with vegetation is obtained, which in addition to the vegetation coverage, also meets the requirement for a certain thermal resistance.

However, it has been shown in practice that the known construction element is not free from disadvantages. The roots of the plants forming the vegetation and located inside structural layer arranged on the insulating board are in more or less direct contact with the insulating board. With longer solar radiation, the heat as intended is held back or reflected by the insulating board and due to the heat reflection associated therewith a heat accumulation develops inside the structural layer. As a result of this heat accumulation, an overheating of the roots of the plants can occur, due to which the growth of the plants suffers. In the worst case, due to the heat accumulation the roots can actually burn, so that the plants die off.

In the case of insulating facades and covering them with vegetation, the known construction element furthermore has the disadvantage that watering is often inadequate and uneven due to the perpendicular position of the structural layer filled with a substrate, because the water flows off downwards. The uneven distribution of moisture and watering causes uneven growth of the plants used for the vegetation coverage. Free vegetation areas not covered with vegetation can thus result, which from an optical point of view make a negative impression.

The object of the invention is to create a pre-covered construction element, which makes it possible to insulate structures without the vegetation suffering from the fact that the construction element has an insulating board.

The invention is based on a construction element covered with vegetation for horizontal, pitched and/or vertical surfaces of structures, with a lower base plate that is embodied as an insulating board, and with an upper vegetation layer with shorter and/or taller plants.

To attain the referenced object it is provided according to the invention that a plant-tolerated adhesive layer is arranged between the insulating board and the vegetation layer, that on the adhesive layer a layer of a material is adhered that renders possible plant growth for shorter and/or taller plants, and that the adhesive layer is embodied in a non-vapor retardant manner, so that it is permeable for water vapor.

The adhesive layer arranged in a novel manner between the vegetation layer and the insulating board has several functions. An important function that is important for a successful, long-term and uniform vegetation coverage of the structural component lies in that the adhesive layer prevents direct contact between the insulating board and the roots of the taller plants. Thus the non-vapor retardant adhesive layer acts like a thermal buffer, which avoids the production of a heat accumulation due to heat reflection and thus counteracts an overheating of the roots of the taller plants.

In the invention the adhesive layer is embodied in a non-vapor retardant manner so that it is permeable for water vapor. Thus the presence of water vapor, which forms due to air humidity, can penetrate outwards through the non-vapor retardant adhesive layer, in order to prevent a waterlogging of the thermal insulation layer.

A further function of the adhesive layer lies in the fixing the material that renders possible a plant growth for shorter and/or taller plants and which is adhered to the adhesive layer.

According to an advantageous further development of the invention, the layer adhered to the adhesive layer is formed by a mineral material. In a further advantageous embodiment, the mineral material is composed of porous and/or open pore material in the form of volcanic rock, slag or expanded clay. Material of this type is advantageously suitable for forming a vegetation base for shorter plants (cryptogams). Mosses are preferably used as shorter plants. In the pre-cultivation and production of the construction element according to the invention, moss sprouts and/or moss spores are applied to the porous and/or open pore material, to which the moss sprouts or moss spores can hold and cling. Thus the mineral material serves as a vegetation base for mosses, which, as is known, do not have any roots.

In the case of the use of taller plants, the invention provides in an advantageous manner that the mineral material is formed by a porous and/or open pore material of different granulations in the form of volcanic rock, slag or expanded clay, wherein spaces are formed in the layer due to the different granulations of the material. These spaces are filled with a nutrient medium that forms the vegetation basis for the taller plants and in which the roots of the taller plants can extend.

In a further advantageous embodiment of the invention, the nutrient medium inserted into the spaces is composed of volcanic rock sand.

The referenced porous and/or open pore material of the layer rendering possible plant growth for shorter and/or taller plants has a high capillarity and water storage ability. A water supply for the plants and thus a uniform vegetation coverage is thus also rendered possible in an advantageous manner when covering a façade with vegetation, that is, in the case of vertical surfaces.

To attain the object according to the invention, according to the preamble of claim 6 it is further provided that a plant-tolerated and non-vapor retardant adhesive layer is arranged between the insulating board and the vegetation layer and that a hygroscopic mineral wool, which forms a vegetation support layer for the shorter and taller plants of the vegetation layer, is adhered to the adhesive layer.

Instead of a porous material, a hygroscopic mineral wool plate is used here, which is fixed by the adhesive layer. A construction element of this type according to the invention is preferably suitable for horizontal surfaces due to the hygroscopic property of the mineral wool plate.

In an expedient embodiment of this solution, a hooking layer is attached on top of the mineral wool plate. Such hooking layers are known per se and preferably embodied in the manner of a looped mat, wherein the hooking layer is composed of a rot-proof material.

The hooking layer is designed to counteract a destruction of the shorter plants—that is, the mosses—by birds. Birds like to use mosses as well as the material of the mineral wool plate as nest material or search for food therein, which can lead to damage to the vegetation layer. The birds are substantially prevented from destroying the moss layer or the mineral wool plate by the hooking layer.

In an advantageous embodiment of the invention, the insulating board in total can be embodied exclusively of an insulating material. However, in addition it is also possible in an expedient embodiment to provide above and below the insulating material an upper and a lower cover plate that are connected to the insulating material.

In an expedient manner, the cover plates can be composed of the material known under the trade name of Rigips or also of waterproof wood boards.

In an advantageous further development of the invention, the two cover plates are respectively provided with a rabbet edge on their ends lying opposite one another. The two cover plates with their respective rabbet edges thus render possible a secure flat connection and a secure placement of individual construction elements on a larger surface, in particular in the case of facades with a vertical surface. The rabbet edges ensure that adjacent cover plates overlap in the region of the rabbet edges.

A further expedient embodiment of the invention lies in that the insulating board is formed by a non-woven fabric with a thermally insulating property.

This is an advantage when the surface on which the construction element covered with vegetation is located is not flat at every point and has irregularities. Since the non-woven fabric is not rigid, but is embodied in an elastic and flexible manner, the insulating board can adapt to the irregularities without any difficulty.

The invention is explained in more detail below based on the exemplary embodiments shown in the drawing. They show:

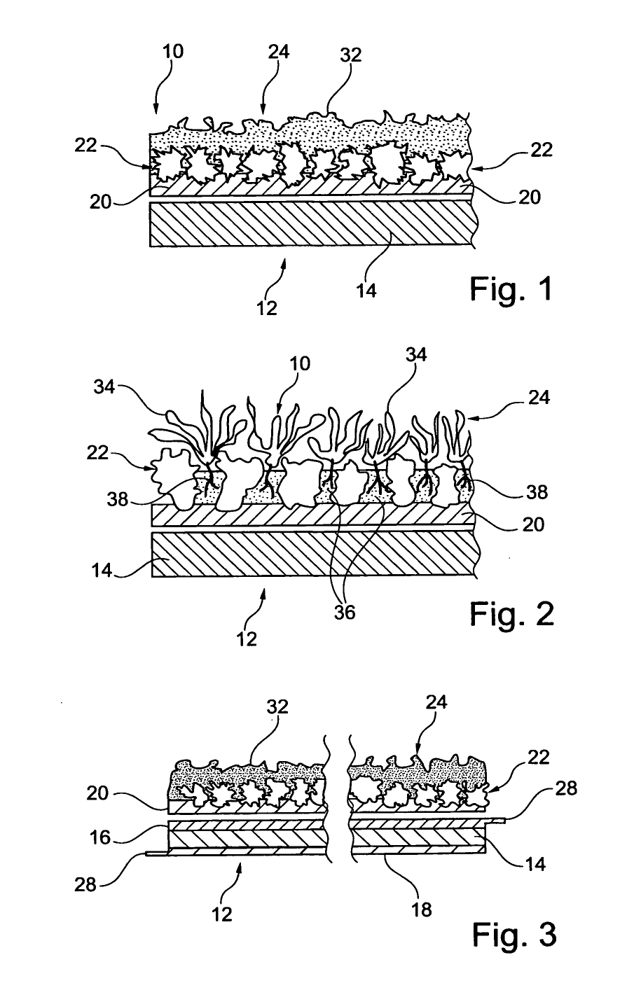

FIG. 1 a diagrammatical cross-sectional view of a greened construction element with shorter plants,

FIG. 2 a diagrammatic cross-sectional view of a construction element covered with vegetation with taller plants,

FIG. 3 a diagrammatic cross-sectional view of a construction element with shorter plants according to a further embodiment of the invention and

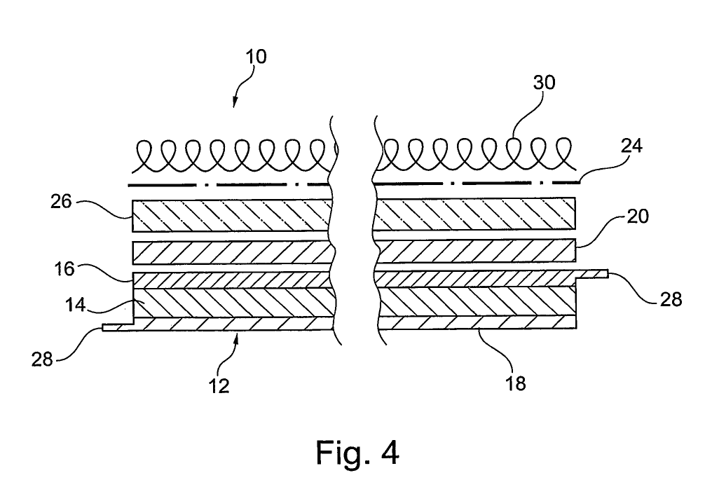

FIG. 4 a diagrammatic cross-sectional view of a construction element according to another solution of the invention.

In the exemplary embodiment of the invention according to FIG. 1, the construction element 10 covered with vegetation comprises on the lower side an insulating board 12, which is composed of an insulating material 14. The insulating material 14 is embodied as thermal insulation material.

A non-vapor retardant and plant-tolerated adhesive layer 20 is attached to the insulating board 12. Porous and/or open pore stones of volcanic rock, slag or expanded clay are adhered to this adhesive layer 20. These stones form a layer 22 of mineral material and serve in FIG. 1 as vegetation base for shorter plants in the form of moss 32. The stones fixed by the adhesive layer 20 have a high capillarity and water storage ability. The granulation of the stones of the mineral layer is about 5-50 mm.

In the pre-cultivation of the construction element 10 for the production of a construction element 10 already covered with vegetation, moss sprouts and/or moss spores are applied onto the surface of the stones of the layer 22. The moss sprouts and/or moss spores cling to the stones or attach themselves thereto. In the course of the subsequent cultivation a moss layer with the mosses 32 grows, which form the upper vegetation layer 24.

The thickness of the adhesive layer 20 is about 5-10 mm. The adhesive layer 20 can be formed, for example, by a mortar mixture or a flexible adhesive. The entire thickness of the construction element 10 is between 5 and 10 cm.

If heat acts on the construction element 10 due to solar radiation, the non-vapor retardant adhesive layer 20 acts like a heat buffer, which avoids the production of a heat accumulation by heat reflection and thus an overheating of the roots or the mosses of the vegetation layer 24. The adhesive layer 20 namely prevents the direct contact between the insulating board 12 and the roots of the taller plants or the moss of the vegetation layer 24.

The insulating board 12 produces a heat protection in the summer. This is supported by the shading of the plants of the vegetation layer 24. Furthermore, due to the ability to store water of the porous material of the layer 22, evaporation cooling can be produced and a partial absorption of the solar radiation also takes place by means of the vegetation layer 24. Particularly in warmer climate zones, this means that less energy has to be consumed to cool the building provided with the construction element 10.

Conversely, due to its insulating board 12, the construction element 10 covered with vegetation also has a protection against cold in winter.

In the exemplary embodiment according to FIG. 2, the upper vegetation layer 24 of the construction element 10 covered with vegetation is formed by taller plants 34, preferably succulents. The layer 22 fixed by the adhesive layer 20 is composed of porous and/or open-pore rocks of different granulations in the form of volcanic rock, slag or expanded clay. The stones are adhered to the adhesive layer 20 such that there are spaces between adjacent stones, and these spaces are filled with a nutrient medium 36, which forms a vegetation base for the taller plants 34 and in which the roots 38 of the taller plants 34 extend. Volcanic rock sand is used as a nutrient medium 36 in the exemplary embodiment according to FIG. 2.

FIG. 3 shows another embodiment of the invention with mosses 32 as upper vegetation layer 24. In contrast to the representations in FIG. 1 and FIG. 2, the insulating board 12 is not composed exclusively of the insulating material 14. Instead, the insulating material 14 is connected to an upper cover plate 16 and to a lower cover plate 18. In this exemplary embodiment of the invention, the insulating board 12 is thus formed by the insulating material 14 and the two cover plates 16 and 18, which are composed of waterproof wood boards, for example.

The two cover plates 16 and 18 respectively have a rabbet edge 28 on their opposite ends. These rabbet edges 28 make it possible to lay several construction elements covered with vegetation easily next to one another on a surface, wherein the rabbet edges 28 of adjacent construction elements 10 overlap one another. A simple, cost-effective and stable production of a layer of several construction elements 10 is possible thereby.

In the exemplary embodiment of the invention according to FIG. 4, instead of the layer 22 in FIGS. 1-3 a hygroscopic mineral wool plate 26 is provided and adhered to the adhesive layer 20. The mineral wool plate 26 renders possible a plant growth for the plants of the vegetation layer 24. Unlike in FIG. 2, with the use of the mineral wool plate 26 it is not necessary to fill spaces with a nutrient medium that the taller plants can grow in the mineral wool plate 26 by themselves.

The vegetation layer 24, shown diagrammatically, which can be formed by shorter and/or taller plants, is located on the mineral wool plate 26

Moreover, a hooking layer 30, which is embodied in a manner known per se in the manner of a looped mat, is attached above the mineral wool plate 26. The hooking layer 30, which forms large cavities, can thereby be composed of a rot-proof material.

The purpose of the hooking layer 30 lies in counteracting a destruction of the surface of the construction element 10 by birds. Birds like to use mosses as well as the material of the mineral wool plate 26 as nest material or they search for food in these layers, which can lead to damage to the vegetation layer 24 and to the mineral wool plate 26. The birds are prevented from damaging the vegetation layer 24 by means of the hooking layer 30.

### LIST OF REFERENCE NUMBERS

### Part of the Specification

10 Construction element
12 Insulating board
14 Insulating material
16 Upper cover plate
18 Lower cover plate
20 Adhesive layer
22 Layer
24 Vegetation layer
26 Hygroscopic mineral wool plate
28 Rabbet edge
30 Hooking layer
32 Moss
24 Taller plants
36 Nutrient medium
38 Roots

1. A construction element covered with vegetation for horizontal, pitched and/or vertical surfaces of structures, comprising:
a lower base plate that is embodied as an insulating board;
an upper vegetation layer with shorter and/or taller plants,
a plant-tolerated adhesive layer arranged between the insulating board and the upper vegetation layer, and
a layer of a material that renders possible plant growth for shorter and/or taller plants adhered on the plant-tolerated adhesive layer; wherein
the plant-tolerated adhesive layer is embodied in a non-vapor retardant manner, so that it is permeable for water vapor.

2. The construction element covered with vegetation according to claim 1, wherein the layer of a material that renders possible plant growth is formed by a mineral material.

3. The construction element covered with vegetation according to claim 2, wherein
the mineral material of the layer of a material that renders possible plant growth is composed of porous and/or open pore material in the form of volcanic rock, slag or expanded clay, and
the mineral material of the layer of a material that renders possible plant growth forms a vegetation base for shorter plants (cryptogams).

4. The construction element covered with vegetation according to claim 2, wherein
the mineral material of the layer of a material that renders possible plant growth is formed by a porous and/or open pore material of different granulations in the form of volcanic rock, slag or expanded clay,
the material is embodied such that there are spaces in the layer of a material that renders possible plant growth,
the spaces are filled with a nutrient medium that forms the vegetation basis for the taller plants, and
the roots of the taller plants extend into the nutrient medium.

5. The construction element covered with vegetation according to claim 4, wherein the nutrient medium is formed by volcanic rock sand.

6. A construction element covered with vegetation for horizontal, pitched and/or vertical surfaces, comprising:
a lower base plate that is embodied as an insulating board,
an upper vegetation layer with shorter and/or taller plants,
a plant-tolerated and non-vapor retardant adhesive layer arranged between the insulating board and the upper vegetation layer, and
a hygroscopic mineral wool plate that forms a vegetation layer for the shorter and/or taller plants of the upper vegetation layer adhered on the plant-tolerated adhesive layer.

7. The construction element covered with vegetation according to claim 6, further comprising a hooking layer attached on top of the mineral wool plate.

8. The construction element covered with vegetation according to claim 1, wherein the insulating board is formed exclusively by an insulating material.

9. The construction element covered with vegetation according to claim 1, wherein the insulating board is composed of an insulating material that is covered above by an upper cover plate and below by a lower cover plate, and the two cover plates are connected to the insulating material.

10. The construction element covered with vegetation according to claim 9, wherein the cover plates are composed of the material known under the trade name Rigips.

11. The construction element covered with vegetation according to claim 9, wherein the cover plates are composed of waterproof wood boards.

12. The construction element covered with vegetation according to claim 9, wherein the cover plates have a rabbet edge each on their ends lying opposite one another.

13. The construction element covered with vegetation according to claim 1, wherein the insulating board is formed by a non-woven fabric with a thermally insulating property.
